(19) United States
(12) Patent Application Publication
(10) Pub. No.: US 2025/0184057 A1
(43) Pub. Date: Jun. 5, 2025

(54) WIRELESS COMMUNICATION METHOD, DISTRIBUTED ANTENNA SYSTEM AND WIRELESS COMMUNICATION APPARATUS

(71) Applicant: NIPPON TELEGRAPH AND TELEPHONE CORPORATION, Tokyo (JP)

(72) Inventors: Takuto ARAI, Musashino-shi (JP); Daisei UCHIDA, Musashino-shi (JP); Tatsuhiko IWAKUNI, Musashino-shi (JP); Shuki WAI, Musashino-shi (JP); Naoki KITA, Musashino-shi (JP)

(73) Assignee: NIPPON TELEGRAPH AND TELEPHONE CORPORATION, Tokyo (JP)

(21) Appl. No.: 18/840,050

(22) PCT Filed: Feb. 25, 2022
(86) PCT No.: PCT/JP2022/008025

§ 371 Date: Aug. 20, 2024

(51) Int. Cl. H04L 5/00; H04B 7/0452

(52) U.S. Cl. CPC H04L 5/0037; H04B 7/0452

(57) ABSTRACT

A wireless communication method in a distributed antenna system including a base station and a plurality of antennas that communicates with one or more terminal stations by spatial multiplexing according to control of the base station, in which each of the plurality of antennas includes a plurality of sub-arrays, the base station allocates a plurality of sub-arrays of different antennas to each of one or more candidate terminal stations to be subjected to communication by spatial multiplexing using two or more sub-arrays among the plurality of sub-arrays, and the plurality of sub-arrays allocated to the candidate terminal station performs spatial multiplexing transmission to the allocated candidate terminal station.

### TECHNICAL FIELD

The present invention relates to a wireless communication method, a distributed antenna system, and a wireless communication device.

### BACKGROUND ART

In a communication system using 5th generation (5G) or the like, a high frequency band of a millimeter wave band is used. In a future communication system such as 6G further evolved from 5G, use of a frequency band higher than that of 5G capable of securing a wider bandwidth is assumed in order to realize further increase in speed and capacity. A high frequency band is known to have a large propagation loss and high straightness, and a distributed antenna system has been studied in order to improve connectivity in covering a communication area (see, for example, Non Patent Literatures 1 and 2).

In the distributed antenna system, by performing single user multiple-input and multiple-output (SU-MIMO) or multi-user MIMO (MU-MIMO) using a plurality of antennas arranged in a distributed manner, it is possible to improve frequency utilization efficiency and improve communication capacity and throughput. In a case of performing communication by MIMO, it is generally assumed that channel state information (CSI) between a distributed antenna and a terminal station (user equipment (UE)) is acquired to reduce inter-stream interference, and a base station (BS) side performs precoding on a downlink and performs post-coding on an uplink.

In a communication system in a high frequency band, it is also assumed that beamforming is performed by a massive MIMO configuration of very many elements in order to secure a gain. On the other hand, from a viewpoint of device cost or the like, application of hybrid beamforming in which an antenna array is divided into sub-arrays and analog beamforming and digital beamforming are used in combination is considered (see, for example, Non Patent Literature 3).

### CITATION LIST

### Non Patent Literature

Non Patent Literature 1: NTT DOCOMO, INC., “DOCOMO 6G White Paper 3.0 version”, November 2021
Non Patent Literature 2: Uchida, Iwakuni, Kita, Onizawa, Kishiyama, Suyama, Nagata, Asai, “Distributed Antenna Systems using High-Frequency-Band targeting 6G Wireless Networks”, IEICE technical report RCS2020-148, pp. 73-78, December 2020.
Non Patent Literature 3: Suyama, Okuyama, Nonaka, Asai, “100 GHz tai Massive MIMO no hybrid BF you subarray haichi (in Japanese) (Subarray Configurations for Hybrid Beamforming of 100 GHz-Band Massive MIMO)”, IEICE Society Conference, B-5-59, September 2021

### SUMMARY OF INVENTION

### Technical Problem

In a case where SU-MIMO is performed in a distributed antenna system using antennas in a sub-array configuration, when antenna allocation is performed according to reception power standards, a probability of allocating a plurality of streams from the same distributed antenna increases. In this case, since a spatial correlation between a base station and a terminal station becomes very high, there is a problem that communication capacity decreases.

In view of the above circumstances, an object of the present invention is to provide a technology capable of improving communication capacity in a situation where spatial multiplexing transmission is performed in a distributed antenna system.

### Solution to Problem

One aspect of the present invention is a wireless communication method in a distributed antenna system including a base station and a plurality of antennas that communicates with one or more terminal stations by spatial multiplexing according to control of the base station, in which each of the plurality of antennas includes a plurality of sub-arrays, the base station allocates a plurality of sub-arrays of different antennas to each of one or more candidate terminal stations to be subjected to communication by spatial multiplexing using two or more sub-arrays among the plurality of sub-arrays, and the plurality of sub-arrays allocated to the candidate terminal station performs spatial multiplexing transmission to the allocated candidate terminal station.

One aspect of the present invention is a distributed antenna system including: a base station; and a plurality of antennas that communicates with one or more terminal stations by spatial multiplexing according to control of the base station, in which each of the plurality of antennas includes a plurality of sub-arrays, the base station includes an allocation unit that allocates a plurality of sub-arrays of different antennas to each of one or more candidate terminal stations to be subjected to communication by spatial multiplexing using two or more sub-arrays among the plurality of sub-arrays, and the plurality of sub-arrays allocated to the candidate terminal station performs spatial multiplexing transmission to the allocated candidate terminal station.

One aspect of the present invention is a wireless communication device including: a base station; and a plurality of antennas that communicates with one or more terminal stations by spatial multiplexing according to control of the base station, in which each of the plurality of antennas includes a plurality of sub-arrays, the base station includes an allocation unit that allocates a plurality of sub-arrays of different antennas to each of one or more candidate terminal stations to be subjected to communication by spatial multiplexing using two or more sub-arrays among the plurality of sub-arrays, and the plurality of sub-arrays allocated to the candidate terminal station performs spatial multiplexing transmission to the allocated candidate terminal station.

### Advantageous Effects of Invention

According to the present invention, it is possible to improve communication capacity in a situation where spatial multiplexing transmission is performed in a distributed antenna system.

### BRIEF DESCRIPTION OF DRAWINGS

FIG. 1 A diagram illustrating an example of a distributed antenna system according to the present embodiment.

FIG. 2 A diagram illustrating a configuration example of a base station according to the present embodiment.

FIG. 3 A flowchart illustrating a flow of processing of the base station in the present embodiment.

### DESCRIPTION OF EMBODIMENTS

Hereinafter, an embodiment of the present invention will be described with reference to drawings.

### (Overview)

In a distributed antenna system 100 in the present embodiment, each antenna arranged in a distributed manner has a sub-array configuration, and stream allocation to the same terminal station is controlled so as to allocate sub-arrays of different antennas arranged in a distributed manner.

In a distributed antenna system in a high frequency band using the sub-array configuration, by focusing on the fact that a spatial correlation is likely to be increased by allocating multiple beams in the same antenna to the same terminal station, and utilizing spatial correlation reduction utilizing an advantage of the distributed antenna system with very simple control, it is possible to improve user throughput.

Hereinafter, specific configurations for achieving the above-described processing will be described.

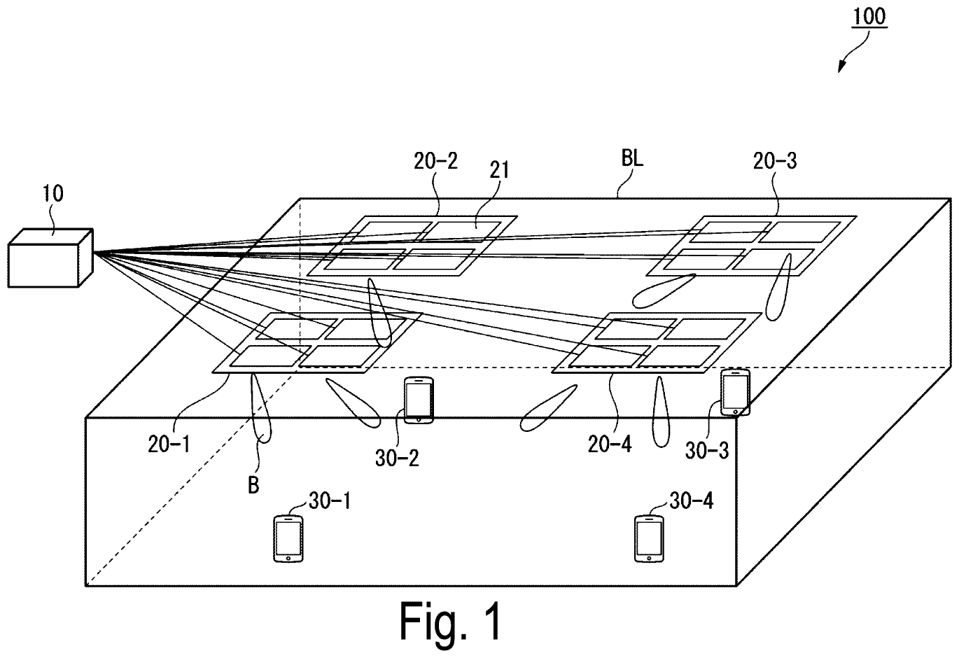

FIG. 1 is a diagram illustrating an example of the distributed antenna system 100 according to the present embodiment. The distributed antenna system 100 includes a base station 10 and a plurality of antennas 20-1 to 20-4. The base station 10 and the plurality of antennas 20-1 to 20-4 are connected by optical transmission lines. Communication between the base station 10 and the plurality of antennas 20-1 to 20-4 is performed by, for example, radio over fiber (RoF). The base station 10 and the plurality of antennas 20-1 to 20-4 are an aspect of a wireless communication device.

In an example illustrated in FIG. 1, the plurality of antennas 20-1 to 20-4 is installed on a ceiling in a building BL and communicates with a plurality of terminal stations 30-1 to 30-4 located in the building BL. For example, the plurality of antennas 20-1 to 20-4 is arranged apart from each other as illustrated in FIG. 1. Each antenna 20 includes a plurality of sub-arrays 21. Note that the numbers of antennas 20, terminal stations 30, and sub-arrays 21 are not limited to the numbers illustrated in FIG. 1. In the following description, the antennas 20-1 to 20-4 will be simply referred to as antennas 20 unless otherwise distinguished.

The base station 10 controls each antenna 20 arranged in a distributed manner by centralized control. The base station 10 realizes communication by SU-MIMO and MU-MIMO by controlling each antenna 20. Specifically, the base station 10 performs SU-MIMO by simultaneously transmitting a plurality of streams from the plurality of antennas 20 to the single terminal station 30, and performs MU-MIMO by simultaneously transmitting a plurality of streams from the plurality of antennas 20 to the plurality of terminal stations 30.

Note that the maximum number of streams that can be simultaneously communicated is determined by the maximum number of SU-MIMO layers and the maximum number of MU-MIMO layers. The base station 10 may use all the antennas 20 arranged in a distributed manner simultaneously for communication or may use only some of the antennas 20.

Each antenna 20 communicates with the terminal station 30. Each antenna 20 includes a plurality of sub-arrays 21. Each sub-array 21 emits radio waves under the control of the base station 10. The antenna 20 communicates with the terminal station 30 to be communicated by performing beamforming using the plurality of array elements to secure a gain in a high frequency band.

Each terminal station 30 includes one or more antennas and communicates with each antenna 20. The terminal station 30 including the plurality of antennas performs communication with the antenna 20 by SU-MIMO. The terminal station 30 may perform beamforming.

Here, SU-MIMO stream allocation performed by the base station 10 will be described using communication from the base station 10 to the terminal station 30 (downlink) as an example. As illustrated in FIG. 1, when each antenna 20 has the sub-array configuration, analog beam simultaneous transmission in a plurality of directions by multiple beams can be performed. Here, in a case where the specific terminal station 30 performs SU-MIMO, the base station 10 allocates the plurality of sub-arrays 21 and performs simultaneous transmission of a plurality of streams. In a case where the sub-array 21 having high reception power is allocated on the basis of a general reception power standard, a probability of allocating the plurality of sub-arrays 21 of the same antenna 20 to the same terminal station 30 increases.

However, since a spatial correlation between the sub-arrays 21 of the same antenna 20 is very high and a spatial correlation with the antenna on the terminal station 30 side is also very high, there is a possibility that throughput decreases due to MIMO transmission. Therefore, in the stream allocation control performed by the base station 10, even if the reception power decreases for a plurality of streams to the same terminal station 30, the sub-arrays 21 of the different antennas 20 are allocated. Thus, it is possible to transmit the plurality of streams and improve the user throughput.

For example, when performing communication with the terminal station 30-1 by SU-MIMO, the base station 10 selects one sub-array of the antenna 20-1 and a sub-array of the antenna 20 other than the antenna 20-1, and performs communication with the terminal station 30-1 by SU-MIMO. As described above, the base station 10 does not select two or more sub-arrays 21 of the same antenna 20 in communication with one terminal station 30. As a result, the sub-arrays 21 having the very high spatial correlation are not selected. As a result, the sub-arrays 21 having the very high spatial correlation are not selected although the reception power may be low for the plurality of streams, so that the user throughput can be improved.

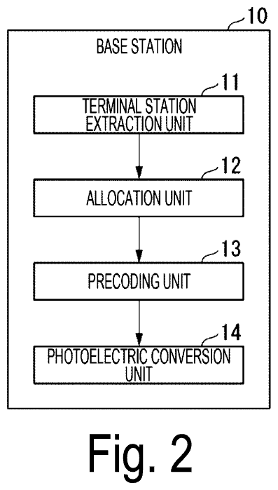

FIG. 2 is a diagram illustrating a configuration example of the base station 10 according to the present embodiment. Note that FIG. 2 illustrates only a configuration related to stream allocation of SU-MIMO that is a feature of the present invention. The base station 10 includes a terminal station extraction unit 11, an allocation unit 12, a precoding unit 13, and a photoelectric conversion unit 14.

The terminal station extraction unit 11 extracts terminal stations 30 that are candidates for spatial multiplexing by MU-MIMO (hereinafter referred to as “candidate terminal stations”). Depending on various types of scheduling, a method of extracting the candidate terminal stations may be any of a method of selecting the candidate terminal stations based on an index such as a rank indicator (RI), a method of selecting the candidate terminal stations based on a proportional fair (PF) standard, a method of selecting the candidate terminal stations based on reception power, and a method of selecting the terminal stations 30 such that interference between the terminal stations 30 is reduced by a positional relationship or the like. Examples of the method of selecting the candidate terminal stations based on the reception power include a method of checking reception power of each terminal station 30 and selecting terminal stations 30 in order from terminal stations having higher reception power, and a method of selecting terminal stations 30 having close reception power.

The allocation unit 12 determines, for each candidate terminal station extracted by the terminal station extraction unit 11, allocation of the sub-array 21 that communicates with the candidate terminal station (hereinafter referred to as “candidate sub-array”) and the number of SU-MIMO layers. As described above, the allocation unit 12 allocates the plurality of sub-arrays 21 of the different antennas 20 for each candidate terminal station. The allocation unit 12 may select, as the candidate sub-array, the sub-array 21 having reception power satisfying the lowest reception sensitivity, or may select the sub-array 21 satisfying a predetermined quality threshold.

The precoding unit 13 calculates a weight matrix W used for communication with each terminal station 30-n that performs communication by MU-MIMO or SU-MIMO. The precoding unit 13 multiplies a transmission signal to be transmitted to the terminal station 30-n by the calculated weight matrix W. As the weight matrix W to be multiplied by the transmission signal to the terminal station 30 that performs communication by SU-MIMO, the precoding unit 13 calculates a weight matrix with the terminal station 30 that performs communication by SU-MIMO. As the weight matrix W to be multiplied by the transmission signal to the terminal station 30 that performs communication by MU-MIMO, the precoding unit calculates a weight matrix using CSI between the antenna 20 and all the terminal stations 30 that perform communication by MU-MIMO as in the conventional case.

The photoelectric conversion unit 14 converts each transmission signal multiplied by the weight matrix W by the precoding unit 13 into an optical signal and transmits the optical signal to the antenna 20.

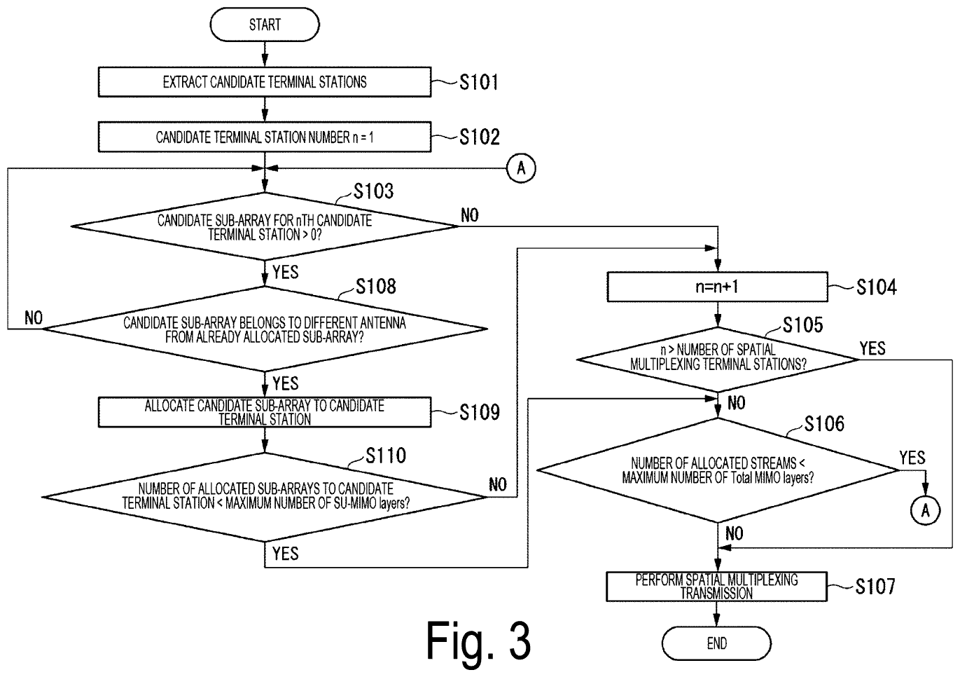

FIG. 3 is a flowchart illustrating a flow of processing of the base station 10 in the present embodiment. Note that, in the processing illustrated in FIG. 3, processing in a case where spatial multiplexing transmission by SU-MIMO is performed will be described.

The terminal station extraction unit 11 extracts candidate terminal stations (step S101). In the following description, the number of candidate terminal stations extracted by the terminal station extraction unit 11 is referred to as the number of spatial multiplexing terminal stations.

The allocation unit 12 assigns a number to each candidate terminal station. For example, the allocation unit 12 sequentially assigns numbers from 1 as candidate terminal station numbers to the candidate terminal stations. The allocation unit 12 substitutes 1 for a candidate terminal station number n (step S102).

The allocation unit 12 extracts, for each candidate terminal station, a sub-array 21 that is a candidate to be allocated as a target for communication with the candidate terminal station (hereinafter referred to as “candidate sub-array”). The allocation unit 12 determines whether or not there is a candidate sub-array for the nth candidate terminal station (step S103). Since n is 1 at the start of processing, for example, the allocation unit 12 determines whether or not there is a candidate sub-array for the first candidate terminal station.

When determining that there is no candidate sub-array for the nth candidate terminal station (step S103: NO), the allocation unit 12 adds 1 to n (step S104). Next, the allocation unit 12 determines whether or not a value of n is larger than the number of spatial multiplexing terminal stations (step S105). When determining that the value of n is equal to or less than the number of spatial multiplexing terminal stations (step S105: NO), the allocation unit 12 determines whether or not the number of allocated streams is less than the maximum number of Total MIMO Layers (step S106).

Here, the number of allocated streams is the number of streams allocated to (n−1)th or less candidate terminal stations. The maximum number of Total MIMO Layers is the number of streams with which the base station 10 can simultaneously perform SU-MIMO and MU-MIMO. When determining that the number of allocated streams is less than the maximum number of Total MIMO Layers (step S106: YES), the allocation unit 12 executes processing of step S103 again.

In a case where the allocation unit 12 determines that the value of n is larger than the number of spatial multiplexing terminal stations in processing of step S105 (step S105: YES), or in a case where the base station 10 determines that the number of allocated streams is larger than the maximum number of Total MIMO Layers in processing of step S106 (step S106: NO), the base station 10 performs spatial multiplexing transmission (step S107). Specifically, the precoding unit 13 first calculates a weight matrix W used for communication with each terminal station 30-n that performs communication by MU-MIMO or SU-MIMO. The precoding unit 13 multiplies a transmission signal to be transmitted to the terminal station 30-n by the calculated weight matrix W. The transmission signal multiplied by the weight matrix W is output to the photoelectric conversion unit 14. The photoelectric conversion unit 14 performs spatial multiplexing transmission by converting the transmission signal multiplied by the partial weight matrix W output from the precoding unit 13 into an optical signal and transmitting the optical signal to the candidate sub-array for the terminal station 30-n (step S107). The candidate sub-array for the terminal station 30-n converts the optical signal output from the base station 10 into an electrical signal, then converts the electrical signal into a radio signal, and performs spatial multiplexing transmission to the terminal station 30-n.

In the processing of step S103, when determining that there is a candidate sub-array for the nth candidate terminal station (step S103: YES), the allocation unit 12 selects one candidate sub-array from among the candidate sub-arrays. The allocation unit 12 determines whether or not the selected candidate sub-array belongs to a different antenna 20 from the sub-array 21 already allocated to the nth candidate terminal station (step S108). The allocation unit 12 excludes the sub-array 21 of the same antenna 20 by processing of step S108.

When determining that the selected candidate sub-array belongs to the same antenna 20 as the sub-array 21 already allocated to the nth candidate terminal station (NO in step S108), the allocation unit 12 executes the processing of step S103 again without allocating the selected candidate sub-array to the nth candidate terminal station. Note that the allocation unit 12 executes the processing of step S103 excluding the already selected candidate sub-array in the nth candidate terminal station.

On the other hand, when determining that the selected candidate sub-array belongs to a different antenna 20 from the sub-array 21 already allocated to the nth candidate terminal station (step S108: YES), the allocation unit 12 allocates the selected candidate sub-array to the nth candidate terminal station (step S109). Next, the allocation unit 12 determines whether or not the number of allocated sub-arrays to the nth candidate terminal station is less than the maximum number of SU-MIMO Layers (step S110).

When determining that the number of allocated sub-arrays to the nth candidate terminal station is less than the maximum number of SU-MIMO Layers (step S110: YES), the allocation unit 12 performs the processing of step S106.

In processing of step S110, when the allocation unit 12 determines that the number of allocated sub-arrays to the nth candidate terminal station is equal to or larger than the maximum number of SU-MIMO Layers (NO in step S110), the allocation unit 12 executes processing of step S104.

As illustrated in FIG. 3, the base station 10 selects the sub-array 21 to be allocated to the candidate terminal station from among the candidate sub-arrays, and additionally allocates the selected sub-array 21 if it does not belong to the same antenna 20 as the already allocated sub-array 21. The base station 10 repeats the processing illustrated in FIG. 3 until the maximum number of Total MIMO Layers of the base station 10 is satisfied or until there is no candidate terminal station. When there is no candidate terminal station and the maximum number of Total MIMO Layers is not satisfied, the allocation unit 12 may add a new candidate terminal station.

Before executing the processing of step S103, the allocation unit 12 may exclude the sub-array 21 belonging to the same antenna 20 as the allocated sub-array 21 from the candidate sub-array, and then execute the processing of step S103.

According to the distributed antenna system 100 configured as described above, when spatial multiplexing transmission is performed in the distributed antenna system, it is possible to improve communication capacity by reducing the spatial correlation between the base station and the terminal station. Specifically, the base station 10 allocates the sub-array 21 of the different antenna 20 as the sub-array 21 to be allocated to the candidate terminal station. As a result, while there is a possibility that the reception power of the plurality of streams transmitted to the candidate terminal station becomes low, the sub-array 21 having the very high spatial correlation is not selected. Therefore, user throughput can be improved. Furthermore, it is possible to reduce spatial correlation in performing SU-MIMO by simple control such as allocating the sub-array 21 of the different antenna 20 as the sub-array 21 to be allocated to the candidate terminal station. Therefore, it is possible to reduce the spatial correlation when performing SU-MIMO in the high-frequency band distributed antenna system using the sub-array configuration by the simple control, and it is possible to improve the user throughput.

Modification examples of the distributed antenna system 100 will be described.

### Modification Example 1

Although the configuration in the downlink from the base station 10 to the terminal station 30 has been described in the above embodiment, the above processing in the distributed antenna system 100 is also applicable to an uplink from the terminal station 30 to the base station 10. For example, the distributed antenna system 100 may perform SU-MIMO by simultaneously transmitting a plurality of streams from the single terminal station 30 to the plurality of antennas 20, and may perform MU-MIMO by simultaneously transmitting a plurality of streams from the plurality of terminal stations 30 to the plurality of antennas.

### Modification Example 2

In the above embodiment, the configuration in which the base station 10 and the plurality of antennas 20 are connected by the optical transmission lines has been described. However, the base station 10 and the plurality of antennas 20 may be connected by transmission lines through which electricity passes, such as coaxial cables. In such a configuration, communication between the base station 10 and the plurality of antennas 20 is performed via an electrical signal. Therefore, the base station 10 does not include the photoelectric conversion unit 14, and transmits each transmission signal multiplied by the partial weight matrix Wn for each terminal station 30 by the precoding unit 13 to the antenna 20 as an electrical signal.

### Modification Example 3

In the above-described embodiment, the configuration in which the sub-array 21 is allocated to each extracted candidate terminal station after the candidate terminal station is extracted by scheduling has been described. However, selection of the terminal station (scheduling) and allocation of the sub-array 21 (connected antenna selection of the terminal station) may be performed in reverse order. Usually, it is also assumed that the candidate terminal station is already connected to one of the sub-arrays 21. Therefore, first, the allocation unit 12 allocates the sub-array 21 to each candidate terminal station, and then the terminal station extraction unit 11 extracts the candidate terminal station to which the sub-array 21 is allocated. For example, the allocation unit 12 may directly allocate or change the sub-array 21 already connected to the candidate terminal station.

Although the embodiment of the present invention has been described in detail with reference to the drawings, the specific configuration is not limited to the embodiment, and includes design and the like within a range without departing from the gist of the present invention.

### INDUSTRIAL APPLICABILITY

The present invention can be applied to a wireless communication system using MIMO.

### REFERENCE SIGNS LIST

10 Base station
20 Antenna
30 Terminal station
11 Terminal station extraction unit
12 Allocation unit
13 Precoding unit
14 Photoelectric conversion unit

1. A wireless communication method in a distributed antenna system including a base station and a plurality of antennas that communicates with one or more terminal stations by spatial multiplexing according to control of the base station, wherein
each of the plurality of antennas includes a plurality of sub-arrays,
the base station allocates a plurality of sub-arrays of different antennas to each of one or more candidate terminal stations to be subjected to communication by spatial multiplexing using two or more sub-arrays among the plurality of sub-arrays, and
the plurality of sub-arrays allocated to the candidate terminal station performs spatial multiplexing transmission to the allocated candidate terminal station.

2. The wireless communication method according to claim 1, wherein
the base station
extracts a plurality of candidate sub-arrays to be allocated among the plurality of sub-arrays for each of the one or more candidate terminal stations, and
allocates a candidate sub-array belonging to an antenna different from an already allocated sub-array among the plurality of extracted candidate sub-arrays to each of the one or more candidate terminal stations for the number of streams to be subjected to the spatial multiplexing.

3. A distributed antenna system comprising: a base station; and a plurality of antennas that communicates with one or more terminal stations by spatial multiplexing according to control of the base station, wherein
each of the plurality of antennas includes a plurality of sub-arrays,
the base station includes an allocator configured to allocate a plurality of sub-arrays of different antennas to each of one or more candidate terminal stations to be subjected to communication by spatial multiplexing using two or more sub-arrays among the plurality of sub-arrays, and
the plurality of sub-arrays allocated to the candidate terminal station performs spatial multiplexing transmission to the allocated candidate terminal station.

4. A wireless communication device comprising: a base station; and a plurality of antennas that communicates with one or more terminal stations by spatial multiplexing according to control of the base station, wherein
each of the plurality of antennas includes a plurality of sub-arrays,
the base station includes an allocator configured to allocate a plurality of sub-arrays of different antennas to each of one or more candidate terminal stations to be subjected to communication by spatial multiplexing using two or more sub-arrays among the plurality of sub-arrays, and
the plurality of sub-arrays allocated to the candidate terminal station performs spatial multiplexing transmission to the allocated candidate terminal station.
